(19) United States
(12) Patent Application Publication
(10) Pub. No.: US 2015/0296846 A1
(43) Pub. Date: Oct. 22, 2015

(54) Dry-Steamed Fine Dried Noodles and Production Device Thereof

(71) Applicant: KEMEN NOODLE MANUFACTURING CO., LTD, Nanxian (CN)

(72) Inventors: Keming CHEN, Nanxian (CN); Wei ZHU, Nanxian (CN); Pingyang GAN, Nanxian (CN); Lizhong CHEN, Nanxian (CN)

(73) Assignee: KEMEN NOODLE MANUFACTURING CO., LTD, Nanxian (CN)

(21) Appl. No.: 14/379,724

(22) PCT Filed: Mar. 5, 2013
(86) PCT No.: PCT/CN2013/072168

§ 371 Date: Aug. 19, 2014

(30) Foreign Application Priority Data
Mar. 5, 2012 (CN) CN201210054704.8

(51) Int. Cl. A23L 1/16; A47J 27/04; A23L 1/01

(52) U.S. Cl. CPC A23L 1/16; A23L 1/0128; A47J 27/04; A47J 2027/043; A47J 2027/006

(57) ABSTRACT

The present invention discloses dry-steamed fine dried noodles. The dry-steamed fine dried noodles with a moisture content of less than or equal to 14.5% are prepared via the processes of dry-steaming, cooling and tempering by using fine dried noodles with a moisture content of 10%-16% as raw material. Compared with the control noodles, the maximum load of the dry-steamed fine dried noodles is improved by 10%-200%, and the cooking loss rate is reduced by 0.5%-1.5%. The dry-steamed fine dried noodles have good taste, boiling fastness, long shelf life, and good edible quality and cooking performance. By performing high temperature dry-steaming treatment on the prepared fine dried noodles, the present invention improves the quality of the fine dried noodles and particularly improves the hardness and toughness of the fine dried noodles while achieving sterilization and anti-insect effects, thus improving the quality guarantee period of the product, and avoiding the occurrence of quality problems such as noodle rupture and poor taste during direct high temperature drying.

### FIELD OF THE INVENTION

The present invention relates to a production of fine dried noodles, specifically to a processing of prepared fine dried noodles and particularly to dry-steamed fine dried noodles and a production device thereof.

### BACKGROUND OF THE INVENTION

In China, the largest country where fine dried noodles are produced and consumed, an industrial production of the fine dried noodles has been realized. At present, a main production process of fine dried noodles is that the raw material is prepared, kneaded, cured, subjected to tabletting, slit, dried, cut off and packaged into finished products by paper packages or plastic packages. Drying fine dried noodles, as a procedure with the highest investment and the highest technology content in a whole production line, refers to dehydrating wet noodles to finally reach a moisture content specified by the production standard. This procedure not only concerns the quality of products, but also has important influence on energy consumption, yield and cost. The occurrence of phenomena during the production, such as noodle rupture, noodle damp and noodle acidification, is basically caused by unreasonable drying equipment and technologies. The difference between drying technologies of fine dried noodles lies in drying temperature and drying time.

Document Production Formula and Process of Fine Dried Noodles (edited by Shen Qun, Chemical Industry Press, 2008) has described drying of fine dried noodles in Section III of Chapter II (P 107). At present, drying of fine dried noodles includes low-temperature low-speed drying which generally means that, the highest temperature of a primary drying area is below 40° C., and the drying time is 5 h-8 h, wherein there are imported and domestic ropeway-pattern drying chambers; intermediate-temperature intermediate-speed drying which generally means that, the highest temperature of a primary drying area is less than 45° C., and the drying time is 3 h-5 h, wherein based on ropeway-pattern high-temperature drying, the drying tunnel is extended and the drying time is prolonged properly, and the drying temperature is reduced, so that the drying temperature and drying time both are between those of the high-temperature drying and the low-temperature drying; and high-temperature high-speed drying which generally means that, the highest temperature of a primary drying area is greater than 45° C. but less than 50° C., and the drying time is less than 3 h (about 2 h, 40 min fastest).

After the processes of rolling, curing, drying and the like are performed on fine dried noodles, due to the restriction of the amount of water added for kneading, the structural arrangement of gluten network tissues is not very uniform, the spacing between tissues is large and incompact, and the distribution of starch grains on a gluten film is not uniform. In addition, the fine dried noodles have ordinary taste, are boilproof and are difficult to store, and generation of worms is prone to happening.

### SUMMARY OF THE INVENTION

An object of the present invention is to provide dry-steamed fine dried noodles having good taste, long shelf life and worm resistance, and a production device thereof. The structural arrangement of gluten network tissues of the dry-steamed fine dried noodles is uniform, the spacing between tissues is small and compact, and the distribution of starch grains on a gluten film is uniform. Compared with the noodles as raw material, the maximum load of the dry-steamed fine dried noodles is improved by 10%-200%, and the cooking loss rate is reduced by 0.5%-1.5%.

To achieve the above object, the present invention employs the following technical solutions.

Dry-steamed fine dried noodles are provided, which are prepared via the following steps by using fine dried noodles with a moisture content of 10%-16% as raw material:

(1) heating and dry-steaming: heating and dry-steaming the fine dried noodles, wherein the heating and dry-steaming employs one of the following two solutions:
solution 1: heating the fine dried noodles to 50° C.-80° C., and keeping for 1 h-35 h under a relative humidity of 60%-80%;
solution 2: feeding the fine dried noodles into a dry-steaming device, heating air in the dry-steaming device to 50° C.-90° C., and keeping for 3 h-100 h under a relative humidity of 60%-80%; and
(2) cooling and tempering: cooling the fine dried noodles dry-steamed in step (1) to room temperature by means of controlling a cooling rate to be 2° C./h-30° C./h and keeping the relative humidity at 60%-80%, thus obtaining dry-steamed fine dried noodles with a moisture content of less than or equal to 14.5%.

Preferably, the maximum load of the dry-steamed fine dried noodles is greater than 0.95 N, and the cooking loss rate is less than 7.5%.

The dry-steamed fine dried noodles are cut off or packaged by paper packages or plastic packages, and then sold.

In solution 1 of step (1), the fine dried noodles are heated via microwaves.

In solution 1 of step (1), the fine dried noodles are heated to 50° C.-80° C., and then are kept for 3 h-24 h under a relative humidity of 60%-80%.

The room temperature is preferably 20° C.-25° C.

The fine dried noodles, used as raw material in the present invention, are conventional fine dried noodles in the prior art, and are preferably prepared from wheat flour or composite powder of wheat flour and fruit and vegetable grains, wherein the content of the wheat flour in the composite powder by mass is greater than or equal to 90%.

The preparation method is as follows: preparing, kneading, curing, tabletting, slitting and drying wheat flour to obtain fine dried noodles with a moisture content of 10%-16%.

The wheat flour should meet the requirements of the national industry standard (LS/T 3202). The fine dried noodles are suspended fine dried noodles, cut-off fine dried noodles in bulk, paper-packaged fine dried noodles, or plastic-packaged fine dried noodles, preferably, suspended fine dried noodles, i.e., fine dried noodles which are suspended and dried in a drying room.

In the prior art, preferably, during the main drying process, the moisture content (28%-34%) in the fine dried noodles is reduced to the moisture content requirement (10%-16%) of the product standard at an appropriate temperature (generally below 50° C.), humidity (70%-90%) and wind speed, thereby being suitable for the storage of the fine dried noodles for a long time.

A device for producing dry-steamed fine dried noodles is provided, including a box body 1 provided with a noodle inlet and a noodle outlet, a heating mechanism disposed in the box body, a humidifier disposed on the box body, a detection mechanism for detecting the temperature and relative humidity of air in the box body, and a control mechanism including a PLC device, the control mechanism being electrically connected to the detection mechanism, the heating mechanism and the humidifier.

The control mechanism controls the temperature, humidity and working time of air in the box body via the heating mechanism and the humidifier by means of the detection of the detection mechanism.

The control range of temperature of the control mechanism is 50° C.-90° C., the control range of relative humidity is 60%-80%, and the control range of working time is 3 h-100 h.

The present invention will be further explained and described as below.

The dry-steamed fine dried noodles provided by the present invention are prepared via the steps of heating, dry-steaming, cooling and tempering by using the prepared fine dried noodles. The fine dried noodles have a moisture content of less than or equal to 14.5%, do not have obvious changes in color and appearance, and are not warped, nonacid, not crispy, and not sticky. The hardness of the fine dried noodles is enhanced. Compared with the control noodles, the maximum load in texture index is improved by 10%-200%, the gluten network structure is compact, the toughness of the fine dried noodles is enhanced, and the cooking loss rate is reduced by 0.5%-1.5%. The fine dried noodles have good taste, boiling fastness, long shelf life, and good edible quality, cooking performance and commodity effect.

In a control experiment, wheat flour is directly processed by the method of the present invention, and then placed in an oven for dry-steaming for 16-20 h at 75° C. Then, the dry-steamed wheat flour is processed into noodles. By evaluating and analyzing the noodles, the result shows that it is difficult to process the wheat flour into noodles, and the prepared noodles cannot reach the effects of the dry-steamed fine dried noodles obtained from the finished fine dried noodles product under the same conditions. Meanwhile, potato starch and cassava starch are processed by the method of the present invention, and then 5% and 10% of starch in added into flour and then the mixture processed into fine dried noodles. The result shows that the noodles does not have obvious difference from the control group (starch is not subjected to high-temperature treatment) and cannot reach the effects of the dry-steamed fine dried noodles obtained from the finished fine dried noodles product under the same conditions.

Compared with the prior art, the present invention has the following advantages:

(1) by performing high temperature dry-steaming treatment on the prepared fine dried noodles, the present invention, breaking through the conventional modes of thinking, improves the quality of the fine dried noodles and particularly improves the hardness and toughness of the fine dried noodles while achieving sterilization and anti-insect effects, thus improving the quality guarantee period of the product, and avoiding the occurrence of quality problems such as noodle rupture and poor taste during direct high temperature drying;
(2) the structural arrangement of gluten network tissues of the dry-steamed fine dried noodles prepared by the present invention is uniform, the spacing between tissues is small and compact, and the distribution of starch grains on the gluten film is uniform; and
(3) compared with the noodles as raw material, the maximum load of the dry-steamed fine dried noodles prepared by the present invention is improved by 10%-200%, and the cooking loss rate is reduced by 0.5%-1.5%.

### BRIEF DESCRIPTION OF THE DRAWINGS

FIG. 1 is a structure diagram of a production device according to the present invention;

FIG. 2 is a scanning electron microscopic image of common fine dried noodles in embodiment 1; and

FIG. 3 is a scanning electron microscopic image of suspended fine dried noodles after dry-steaming for 9 h at 85° C. in embodiment 1.

### DETAILED DESCRIPTION OF THE EMBODIMENTS

The present invention will be further described as below in combination with accompanying drawings and embodiments. The percentage content in the embodiments refers to percentage content by mass.

### Embodiment 1

Fine dried noodles are prepared by the following steps:

(1) Production of fine dried noodles: producing fine dried noodles is an industrial process for producing common fine dried noodles, including: processing raw material into fine dried noodles after steps of preparing, kneading, curing, tabletting, slitting and drying, wherein the moisture content of the fine dried noodles is 10%-16%. The fine dried noodles in this embodiment are suspended fine dried noodles, that is, the fine dried noodles are suspended and dried in a drying room, wherein the moisture content is 14%. The raw material in this embodiment is wheat flour.

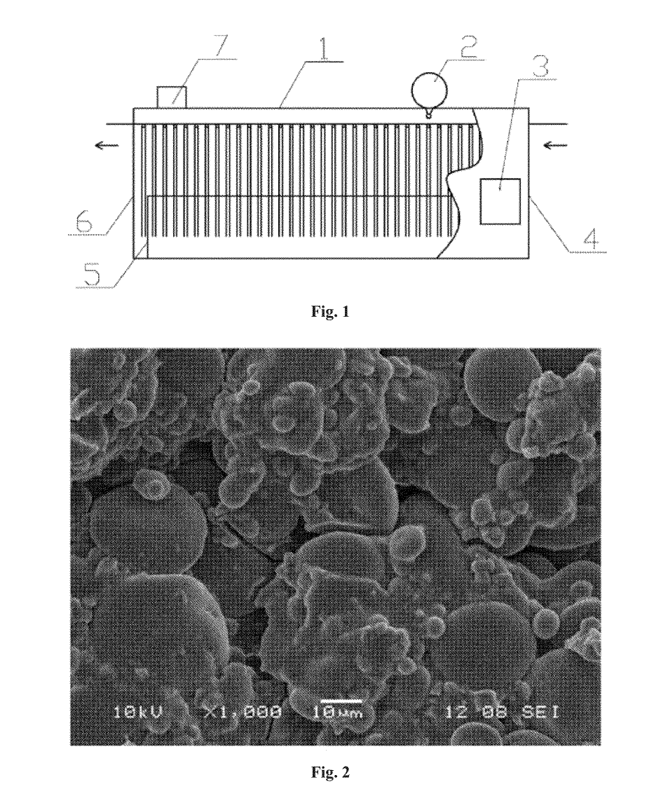

It can be seen from FIG. 2 that, although the processes of rolling, curing, drying and the like are performed on common fine dried noodles, the structural arrangement of gluten network tissues of the common fine dried noodles is not uniform, the spacing between tissues is large and incompact and the distribution of starch grains on the gluten film is not uniform due to the restriction of the amount of water added for kneading or the like.

(2) Dry-steaming: in order to heat the fine dried noodles, the heating and dry-steaming method in this embodiment is as follows: fine dried noodles which have been normally dried in the drying room are suspended and fed into a dry-steaming device, air in the dry-steaming device is heated to 85° C. and kept for 24 h, and the relative humidity is kept at 80%.

It can be seen from FIG. 1 that, a device for producing dry-steamed fine dried noodles (i.e., a dry-steaming device) includes a box body 1 provided with a noodle inlet 4 and a noodle outlet 6, a heating mechanism 5 disposed in the box body 1, a humidifier 7 disposed on the box body 1, a detection mechanism 2 for detecting the temperature and relative humidity of air in the box body 1, and a control mechanism 3 including a PLC device, the control mechanism 3 being electrically connected to the detection mechanism 2, the heating mechanism 5 and the humidifier 7.

The control mechanism 3 controls the temperature, humidity and working time of air in the box body 1 via the heating mechanism 5 and the humidifier 7 by means of detection of the detection mechanism 2.

The control range of temperature of the control mechanism 3 is 50° C.-90° C., the control range of relative humidity is 60%-80%, and the control range of working time is 3 h-100 h.

(3) cooling and tempering: the fine dried noodles dry-steamed in step (2) are cooled to room temperature, wherein a cooling rate is 2° C./h-30° C./h, the relative humidity is kept at 60%-80%, and the moisture content of the fine dried noodles is controlled to be less than or equal to 14.5%.

In this embodiment, the cooling rate is 30° C./h, the relative humidity is kept at 80%, and the moisture content of the fine dried noodles is controlled to be 11.0%.

The dry-steamed fine dried noodles are prepared via the steps of heating, dry-steaming, cooling and tempering by using the prepared fine dried noodles. The fine dried noodles have a moisture content of less than or equal to 14.5% (11% in this embodiment), do not have obvious changes in color and appearance, and are not warped, nonacid, not crispy, and not sticky. With the increase of dry-steaming time, the maximum load (reflecting hardness of the dry-steamed fine dried noodles) produced by the above process will rise. Compared with the control noodles, the hardness of the fine dried noodles is enhanced, and the maximum load in texture index is improved by 10%-200%. Furthermore, during dry-steaming, the fine dried noodles are further cured, the gluten network structure is compact, the toughness of the fine dried noodles is enhanced prominently, and the cooking loss rate is reduced by 0.5%-1.5% in comparison with the control noodles (refer to the attached table). The fine dried noodles have good taste, boiling fastness, long shelf life, and good edible quality, cooking performance and commodity effect.

Attached Table shows test data of maximum load in texture index and cooking loss rate of suspended fine dried noodles after dry-steaming at 85° C.

| Hold time (h) | Maximum load/N | Cooking loss rate (%) |
|---|---|---|
| 0 | 0.8552 | 8.0 |
| (control) | | |
| 3 | 0.9568 | 7.5 |
| 6 | 1.1416 | 7.3 |
| 9 | 1.3674 | 7.2 |
| 12 | 1.5258 | 6.9 |
| 20 | 1.6010 | 6.8 |
| 24 | 2.0939 | 6.7 |

Note:
The texture analyzer is a British TA-PLUS texture analyzer, the number n of the samples to be tested is 3, the thickness is 0.75 mm-0.76 mm, and the value is an average value.

It can be seen from the attached table that, the maximum load in the texture index is improved by 11.9% (keeping for 3 h) and 144.8% (keeping for 24 h) in comparison with the control noodles, the gluten network structure tends to be compact, the toughness of the fine dried noodles is enhanced prominently, and the cooking loss rate is reduced by 0.5% (keeping for 3 h) and 1.3% (keeping for 24 h) in comparison with the control noodles (refer to the attached table).

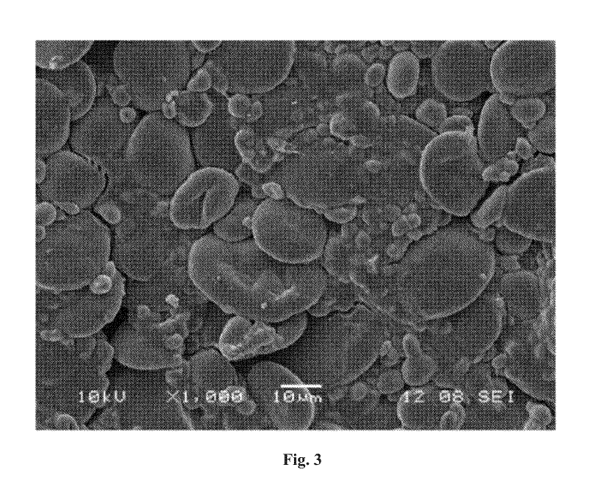

It can be seen from FIG. 3 that, the arrangement of gluten network tissues of the dry-steamed fine dried noodles obtained after dry-steaming treatment becomes regular, the spacing between tissues is small, and the distribution of starch grains on the gluten film is uniform. It can be seen that the dry-steaming treatment has a function of improving the tissue structure of dried noodles, and this is consistent with the test data and the result of sensory evaluation of the texture index and cooking loss rate. The fine dried noodles are cut off, paper-packaged or plastic-packaged as required after dry-steaming treatment.

### Embodiment 2

In step (1) of the present invention, the raw material is composite powder of wheat flour and fruit and vegetable grains, wherein the wheat flour accounts for 92%, while the fruit and vegetable grains (sorghum flour) account for 8%.

In step (2) of the present invention, the temperature is raised to 70° C. and then kept for 24 h, and the relative humidity is kept at 75%.

By detecting the dry-steamed fine dried noodles, the moisture content of the dry-steamed fine dried noodles is 12.0%, the maximum load in the texture index is improved by 79.5% in comparison with the control noodles, the gluten network structure tends to be compact, the cooking loss rate is reduced by 1.1% in comparison with the control noodles, and the remaining is the same as those in embodiment 1.

### Embodiment 3

In step (1) of the present invention, the raw material is composite powder of wheat flour and fruit and vegetable grains, wherein the wheat flour accounts for 95%, the vegetable powder accounts for 2%, and the soybean meal accounts for 3%.

In step (2) of the present invention, the temperature is raised to 75° C. and then kept for 6.5 h, and the relative humidity is kept at 78%.

After the end of dry-steaming, the fine dried noodles are cooled to room temperature, wherein the cooling rate is 25° C./h and the relative humidity is kept at 75% in this embodiment.

By detecting the dry-steamed fine dried noodles, the moisture content of the dry-steamed fine dried noodles is 12%, the maximum load in the texture index is improved by 34.9% in comparison with the control noodles, the gluten network structure tends to be compact, the cooking loss rate is reduced by 0.5% in comparison with the control noodles, and the remaining is the same as those in embodiment 1.

### Embodiment 4

In step (1) of the present invention, the raw material is composite powder of wheat flour and fruit and vegetable grains, wherein the wheat flour accounts for 92%, and the fruit and vegetable grains (buckwheat flour) account for 8%. The fine dried noodles are products after being dried, cut off and packaged with paper shrink films.

In step (2) of the present invention, the temperature is raised to 80° C. and then kept for 24 h, and the relative humidity is kept at 80%.

In the present invention, to enable the fine dried noodles to be heated uniformly and ensure the consistence of the quality of the fine dried noodles, the fine dried noodles are placed uniformly in the dry-steaming device.

After the end of dry-steaming, the fine dried noodles are cooled to room temperature, wherein the cooling rate is 15° C./h and the relative humidity is kept at 70% in this embodiment.

By detecting the dry-steamed fine dried noodles, the moisture content of the dry-steamed fine dried noodles is 11.8%, the maximum load in the texture index is improved by 21.3% in comparison with the control noodles, the gluten network structure tends to be compact, the cooking loss rate is reduced by 0.8% in comparison with the control noodles, and the remaining is the same as those in embodiment 1.

### Embodiment 5

In step (1) of the present invention, the raw material is composite powder of wheat flour and fruit and vegetable grains, wherein the wheat flour accounts for 95%, and the fruit and vegetable grains (green bean powder) account for 5%. The fine dried noodles are products after being dried, cut off and packaged with plastic packages.

In step (2) of the present invention, the temperature is raised to 50° C. and then kept for 100 h, and the relative humidity is kept at 60%.

After the end of dry-steaming, the fine dried noodles are cooled to room temperature, wherein the cooling rate is 10° C./h and the relative humidity is kept at 60% in this embodiment.

By detecting the dry-steamed fine dried noodles, the moisture content of the dry-steamed fine dried noodles is 12.0%, the maximum load in the texture index is improved by 15.3% in comparison with the control noodles, the gluten network structure tends to be compact, the cooking loss rate is reduced by 0.5% in comparison with the control noodles, and the remaining is the same as those in embodiment 1 and embodiment 4.

### Embodiment 6

In step (1) of the present invention, the fine dried noodles are cut off and packaged in bulk after being dried.

In step (2) of the present invention, the temperature is raised to 75° C. and then kept for 30 h, and the relative humidity is kept at 80%.

After the end of dry-steaming, the fine dried noodles are cooled to room temperature, wherein the cooling rate is 2° C./h and the relative humidity is kept at 80% in this embodiment.

By detecting the dry-steamed fine dried noodles, the moisture content of the dry-steamed fine dried noodles is 12.5%, the maximum load in the texture index is improved by 35.3% in comparison with the control noodles, the gluten network structure tends to be compact, the cooking loss rate is reduced by 1.0% in comparison with the control noodles, the fine dried noodles are paper-packaged or plastic-packaged as required after dry-steamed, and the remaining is the same as those of embodiment 1 and embodiment 4.

### Embodiment 7

In step (1) of the present invention, the fine dried noodles are cut off and packaged in bulk after being dried.

To improve production efficiency, in step (2) of the present invention, the heating and dry-steaming method is heating the fine dried noodles by microwaves. The fine dried noodles are heated to 50° C.-80° C. (70° C. in this embodiment) and then kept for 1 h-35 h (1 h in this embodiment), and the relative humidity is kept at 60%-80% (75% in this embodiment).

After the end of dry-steaming, the fine dried noodles are cooled to room temperature, wherein the cooling rate is 2° C./h and the relative humidity is kept at 75% in this embodiment.

By detecting the dry-steamed fine dried noodles, the moisture content of the dry-steamed fine dried noodles is 12.0%, the maximum load in the texture index is improved by 23.7% in comparison with the control noodles, the gluten network structure tends to be compact, the cooking loss rate is reduced by 0.7% in comparison with the control noodles, the fine dried noodles are paper-packaged or plastic-packaged as required after dry-steamed, and the remaining is the same as those of embodiment 1 and embodiment 4.

### Embodiment 8

In step (1) of the present invention, the fine dried noodles are packaged in bulk after being dried and cut off.

To improve production efficiency and reduce cost, in step (2) of the present invention, the fine dried noodles are heated to 50° C.-80° C. (50° C. in this embodiment) at first, then fed into a dry-steaming device at 50° C.-80° C. (50° C. in this embodiment) and kept for 1 h-35 h (35 h in this embodiment), and the relative humidity is kept at 60%-80% (60% in this embodiment).

After the end of dry-steaming, the fine dried noodles are cooled to room temperature, wherein the cooling rate is 2° C./h and the relative humidity is kept at 70% in this embodiment.

By detecting the dry-steamed fine dried noodles, the moisture content of the dry-steamed fine dried noodles is 12.0%, the maximum load in the texture index is improved by 15.4% in comparison with the control noodles, the gluten network structure tends to be compact, the cooking loss rate is reduced by 0.6% in comparison with the control noodles, the fine dried noodles are paper-packaged or plastic-packaged as required after dry-steamed, and the remaining is the same as those of embodiment 1 and embodiment 4.

1. A method for creating dry-steamed fine dried noodles, which are prepared via the following steps by using fine dried noodles with a moisture content of 10% to 16% as raw material comprising:
(a) heating the fine dried noodles to between 50° C. and 80° C., and keeping the fine dried noodles in an environment with relative humidity of between 60% and 80% for between 1 and 35 hours;
(b) cooling said fine dried noodles to room temperature with a controlled cooling rate of between 2° C./hour and 30° C./hour in an environment with relative humidity of between 60% and 80%;
wherein the result is dry-steamed fine dried noodles with a moisture content of less than or equal to 14.5%.

2. A method for creating dry-steamed fine dried noodles according to claim 1, where in the heating step the fine dried noodles are heated via microwaves.

3. A method for creating dry-steamed fine dried noodles according to claim 1, where in the heating step the fine dried noodles are kept in the environment with relative humidity of between 60% and 80% for between 3 and 24 hours.

4. A method for creating dry-steamed fine dried noodles according to claim 1 wherein the fine dried noodles preparation material is selected from a group consisting of wheat flour and composite powder of wheat flour and fruit and vegetable grains, of which the wheat flour by mass is greater than or equal to 90%.

5. An apparatus for dry-steaming fine dried noodles, comprising:
a box body (1) provided with a noodle inlet (4) and a noodle outlet (6), a heating mechanism (5) disposed in the box body (1), a humidifier (7) disposed on the box body (1), a detection mechanism (2) for detecting the temperature and relative humidity of air in the box body (1), and a control mechanism (3) comprising a PLC device, wherein the control mechanism (3) is electrically connected to the detection mechanism (2), the heating mechanism (5), and the humidifier (7).

6. A method for creating dry-steamed fine dried noodles according to claim 2, where in the heating step the fine dried noodles are kept in the environment with relative humidity of between 60% and 80% for between 3 and 24 hours.

7. A method for creating dry-steamed fine dried noodles according to claim 2 wherein the fine dried noodles preparation material is selected from a group consisting of wheat flour and composite powder of wheat flour and fruit and vegetable grains of which the wheat flour by mass is greater than or equal to 90%.

8. A method for creating dry-steamed fine dried noodles, which are prepared using fine dried noodles with a moisture content of 10%-16% as raw material comprising:
(a) feeding the fine dried noodles into a dry-steaming device;
(b) heating the air in said dry-steaming device to between 50° C. and 90° C. and keeping the environment in said dry-steaming device at a relative humidity between 60% and 80% for between 3 and 100 hours;
(b) cooling said fine dried noodles to room temperature with a controlled cooling rate of 2° C./hour and 30° C./hour in an environment with relative humidity of between 60% and 80%;
wherein the result is dry-steamed fine dried noodles with a moisture content of less than or equal to 14.5%.

9. A method for creating dry-steamed fine dried noodles according to claim 8, where in the heating step the fine dried noodles are heated via microwaves.

10. A method for creating dry-steamed fine dried noodles according to claim 8, where in the heating step the fine dried noodles are kept in the environment with relative humidity of between 60% and 80% for between 3 and 24 hours.

11. A method for creating dry-steamed fine dried noodles according to claim 9, where in the heating step the fine dried noodles are kept in the environment with relative humidity of between 60% and 80% for between 3 and 24 hours.

12. A method for creating dry-steamed fine dried noodles according to claim 8 wherein the fine dried noodles preparation material is selected from a group consisting of wheat flour and composite powder of wheat flour and fruit and vegetable grains of which the wheat flour by mass is greater than or equal to 90%.

13. A method for creating dry-steamed fine dried noodles according to claim 9 wherein the fine dried noodles preparation material is selected from a group consisting of wheat flour and composite powder of wheat flour and fruit and vegetable grains of which the wheat flour by mass is greater than or equal to 90%.
